(19) United States
(12) Patent Application Publication
(10) Pub. No.: US 2003/0116024 A1
(43) Pub. Date: Jun. 26, 2003

(54) Fermentation apparatus with washing means

(75) Inventor: Marco Francia, Casale Monferrato (IT)

Correspondence Address: SUGHRUE MION, PLLC, 2100 Pennsylvania Avenue, NW, Washington, DC, 20037-3213, US

(73) Assignee: GIMAR TECNO S.R.L.

(21) Appl. No.: 10/301,700

(22) Filed: Nov. 22, 2002

(30) Foreign Application Priority Data
Nov. 23, 2001 (IT) TO2001A001097

(51) Int. Cl. A23L 1/00

(52) U.S. Cl. 99/275

(57) ABSTRACT

Fermentation apparatus, particularly for wine-making, of the type comprising a main tank and a secondary tank, disposed on top of the main tank, having a lower opening for the discharge of the fermentation liquid into the main tank, and provided with a closure member movable vertically between a position for closure of the lower opening and an open position. Means for the output of jets of washing liquid are associated with the closure member in a manner such that the vertical movement of the closure member and of the washing means associated therewith enables the position of the washing jets to be adjusted.

The present invention relates to a fermentation apparatus, particularly for wine-making, of the type comprising a main tank and a secondary tank, arranged on top of the main tank, having a lower opening for the discharge of the fermentation liquid into the main tank, and provided with a closure member movable vertically between a position for closure of the lower opening and an open position.

A fermentation apparatus of the type mentioned above is known and is described, for example, in patents IT 1 289 672, 1 293 978 and U.S. Pat. No. 6,279,457 in the name of the Applicant.

The technical problem to which the invention relates is the washing of the internal walls of the fermentation apparatus, which has to be performed periodically in order to remove the residues and encrustations that are deposited on the walls in the course of fermentation, and which is essential when the same apparatus has to be used for wine-making with grapes of different kinds.

At the moment, this operation is generally performed manually with the aid of cleaning apparatus using water and is expensive in terms of time and labour, as well as very difficult, because of the poor accessibility of critical regions of the walls of the tanks such as, in particular, the surface of the base of the secondary tank that faces the main tank.

The object of the invention is to provide improved apparatus which enables washing to be performed automatically but without leading to a substantial increase in the production costs of the apparatus.

In view of this object, the subject of the invention is a fermentation apparatus as defined in the appended claims.

Further characteristics and the advantages of the apparatus will become clear from the following detailed description which is given with reference to the appended drawings provided purely by way of non-limiting example, in which:

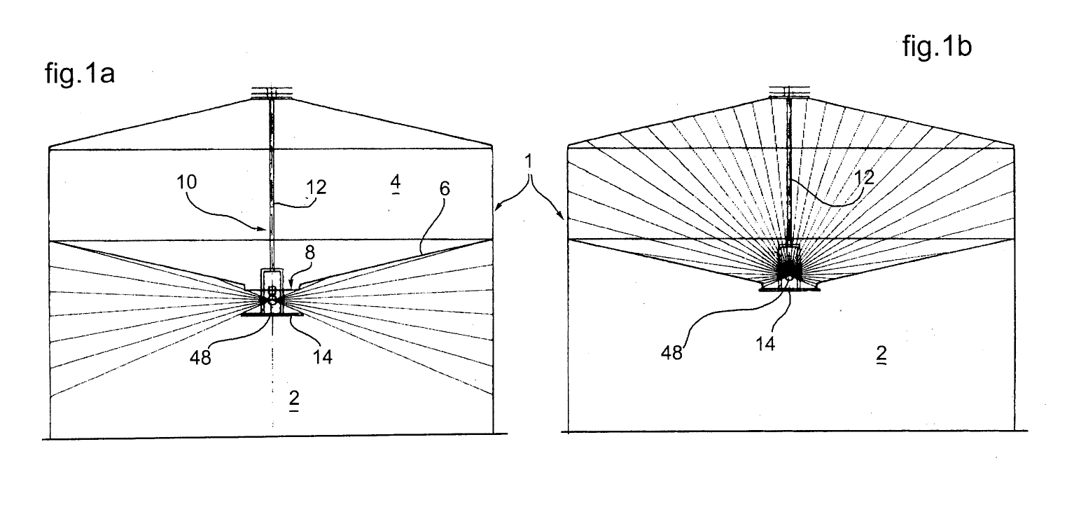

FIGS. 1a and 1b are schematic views showing, in section, a fermentation apparatus with associated washing means, shown in two operative positions a) and b),

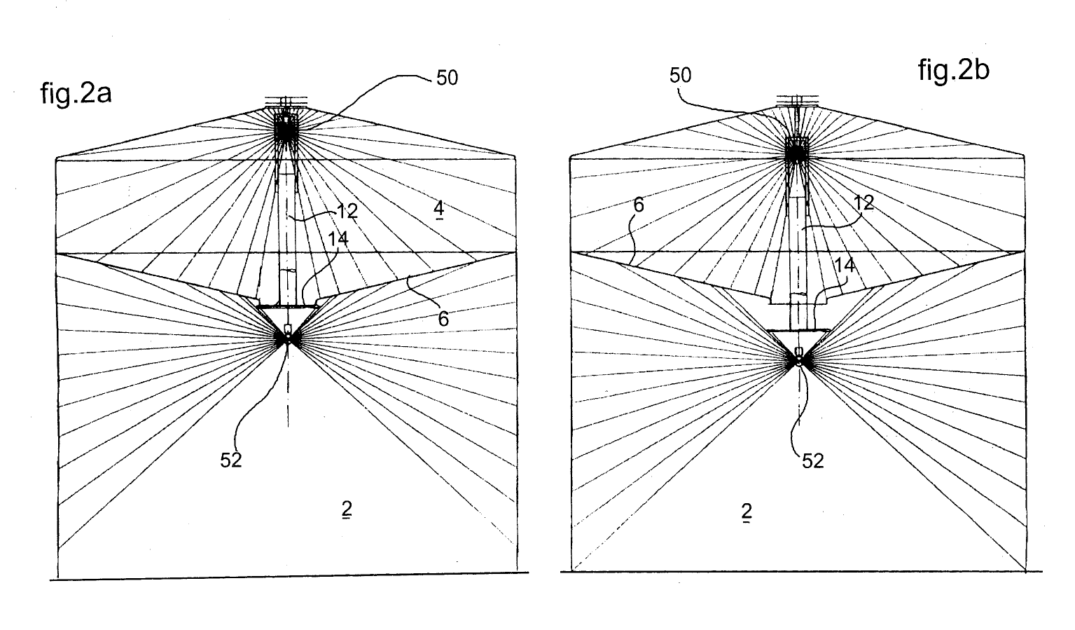

FIGS. 2a, 2b, 3a, 3b, 4a and 4b are schematic views of the apparatus, similar to FIGS. 1a and 1b and relating to three further embodiments, each shown in two operative configurations,

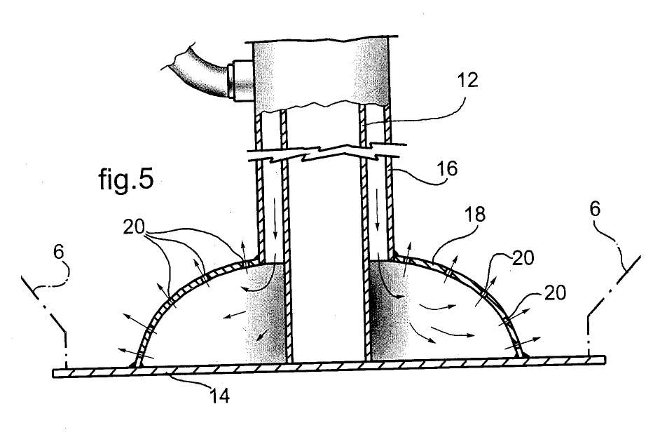

FIG. 5 is a section through a washing device according to the invention,

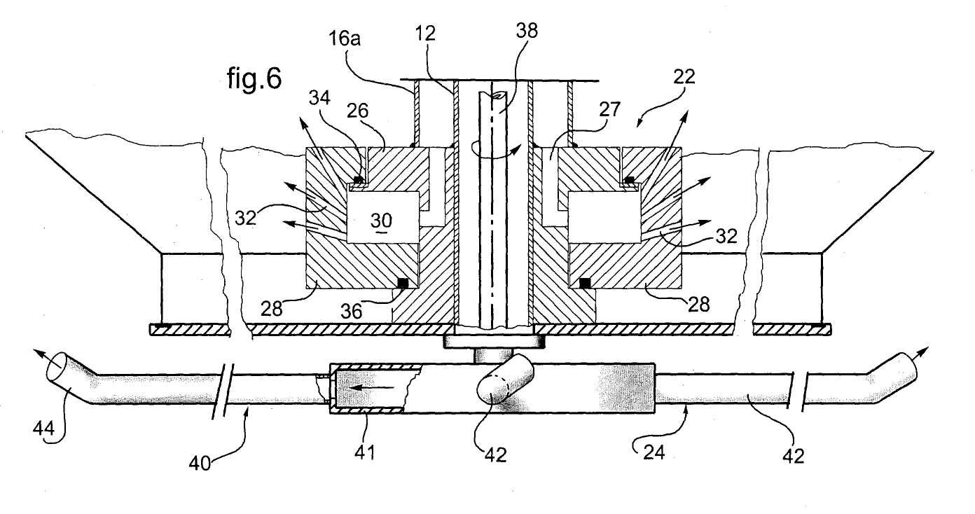

FIG. 6 is a schematic section through another washing device according to the invention, and

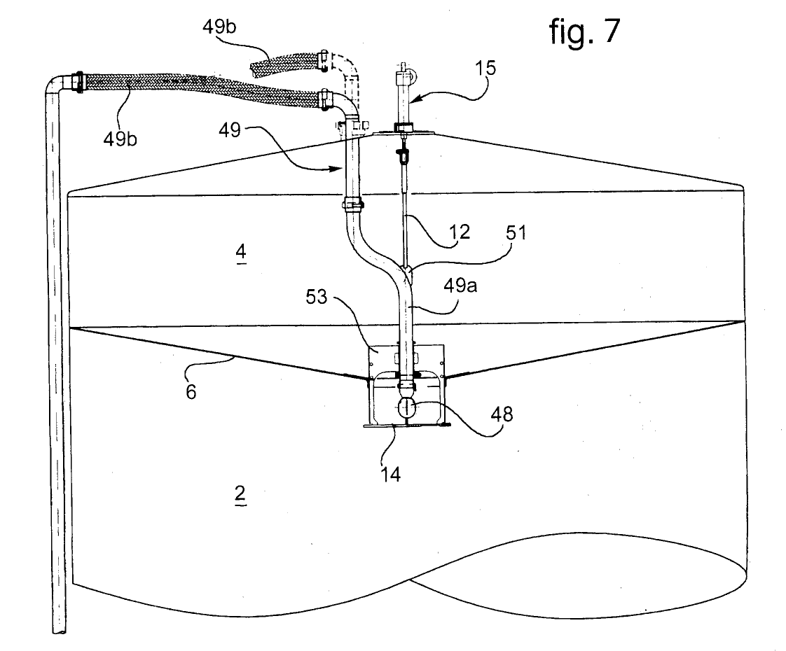

FIG. 7 is a schematic section showing the mounting of another washing device.

In the drawings, an automatic fermentation tank is generally indicated 1 and comprises a main tank 2 for holding pressed grapes and a secondary tank 4, disposed on top of the main tank and having a base 6 with a lower discharge opening 8 for discharging the fermentation liquid into the main tank 2, the fermentation liquid being supplied from the bottom 6 of the main tank 2 to the secondary tank 4 by means of a repassing pipe, not shown.

A closure member 10 with a rod 12 and a plate 14 is associated with the secondary tank 4, in particular with the lower opening 8. The closure member 10 is operated by an actuator 15 (FIG. 7) and is movable vertically between a closure position, in which the plate 14 engages the discharge opening 8, and an open position.

The invention is based on the idea of associating with the closure member 10 washing means which are suitable for delivering jets of a washing liquid onto the internal walls of the fermentation apparatus, making use of the vertical movement of the closure member 10 to vary the position in which the liquid is delivered and to enable different regions of the walls of the apparatus to be washed, particularly critical areas such as the surface of the base 6 of the secondary tank 4 that faces the main tank 2.

In the currently-preferred embodiment, the plate 14 is positioned inside the main tank 2 so that the closure travel of the closure member 10 involves the raising of the plate 14 towards the base 6 until it engages the opening 8.

In combination with the above-mentioned characteristic, the washing means are also preferably mounted on top of the plate 14 so that a single washing device enables the internal walls of the secondary tank 4, and the walls which delimit the upper portion of the main tank 2, to be washed.

FIG. 5 shows a particularly simple, embodiment of the static washing means which comprises a washing-liquid supply duct 16 which surrounds the rod 12 of the closure member 10 and supplies the liquid to a hollow body 18, for example, a cap-shaped body that is welded to the plate 14 of the closure member 10. The hollow body 18 has a plurality of holes 20 for the output of radial jets of washing liquid.

The configuration of FIG. 5, in which the hollow body 18 is disposed on top of the plate 14 and in which the plate 14 is movable beneath the opening 8, is currently preferred because the vertical movement of the plate 14 permits selective washing both of the internal wall of the upper tank 4 and of the walls of the main tank 2. The invention is, however, intended also to include within its scope an arrangement in which the hollow output body 18 is mounted beneath the plate 14.

In a currently-preferred embodiment the washing means are dynamic, that is, with rotating jets.

For example, FIG. 6 shows an embodiment in which first washing means 22 and second washing means 24, both of dynamic type, are associated with the closure member 10. The invention is, however, intended to include within its scope solutions in which only one of the washing means 22 or 24 is associated with the closure member 10.

The washing means 22 comprise a stator body 26 which is fixed firmly to the rod 12 of the closure member, on top of the plate 14, and is provided with a duct 27 communicating with a washing-liquid supply duct 16a which surrounds the rod 12. A rotor 28 is restrained rotatably in sliding engagement on the stator body 26 and defines, with the stator 26, a chamber 30 communicating with the duct 27.

The side wall of the rotor body 28 has a plurality of inclined ducts 32 for the output of jets of washing liquid. A hydraulic seal between the stator body 26 and the rotor body 28 can be achieved with self-lubricating sealing rings 34 and 36, although—for the purposes of the device—it is not necessary to achieve a complete hydraulic seal.

The rotor body is rotated by virtue of the reaction force generated on the rotor by the jets of liquid.

The washing means 24 comprise a pipe 38 which is positioned inside the rod 12 and which supplies the washing liquid to a device 40 with rotating tubular arms that are mounted rotatably beneath the plate 14. The device 40 with rotating arms typically comprises a manifold body 41 which receives the washing liquid from the pipe 38 and a plurality of tubular arms 42 provided, at their ends, with inclined nozzles 44, or with holes, for the output of jets of washing liquid.

Naturally, the washing means may adopt configurations other than those described and illustrated herein. For example, other rotating jet or spray washing devices such as, for example, a commercially available device 48 with a rotating head may be used within the scope of the invention.

This device comprises basically a hollow, bowl head shaped, provided with a plurality of liquid-outlet holes, and connected rotatably to the end of a tubular liquid-supply pipe 49 (FIG. 7) with the use of a rolling bearing.

The pipe 49 has a rigid end portion 49a connected to the rod 12 by fixing means 51, and at least one flexible portion 49b. Liquid-deflecting fins 53 may be connected to the end portion 49a of the pipe 49.

Alternatively, the washing liquid may be supplied to the washing device 48 by means of a supply duct (not shown) inside the rod 12 and extending inside the actuator 15.

FIGS. 1a and 1b show schematically a solution in which a rotatable-head device 48 of the type mentioned above is associated with the closure member 10, on top of the plate 14. The vertical movement of the closure member 10 enables the washing-liquid output jets to be directed against the side walls of the main tank 2 and towards the lower surface of the base 6 when the closure member 10 is in the open position (FIG. 1a) whereas, when the closure member 10 is in the closure position, the output jets are directed towards the walls which define the upper tank 4 (FIG. 1b).

In the embodiment shown in FIGS. 2a and 2b two output devices, 50 and 52, respectively, for example of the type mentioned above, are provided—in association with the rod 12—and are connected beneath the plate 14 and at the upper end of the rod 12, respectively, each device being provided with an independent washing-liquid supply duct.

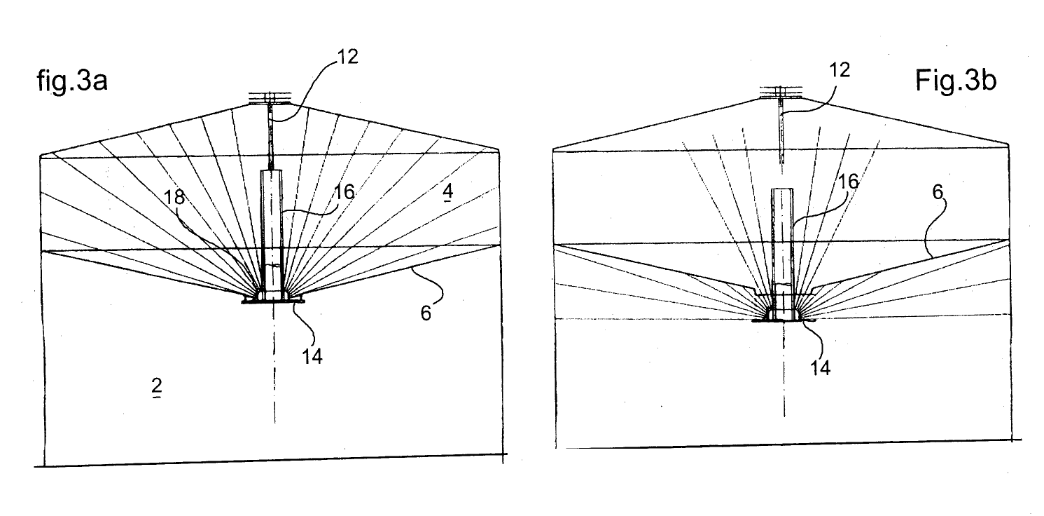

In the diagrams of FIGS. 3a and 3b, the washing means, for example, of the type indicated 22 (FIG. 6) or 18 (FIG. 5) above, are associated with the rod 12, on top of the plate 14.

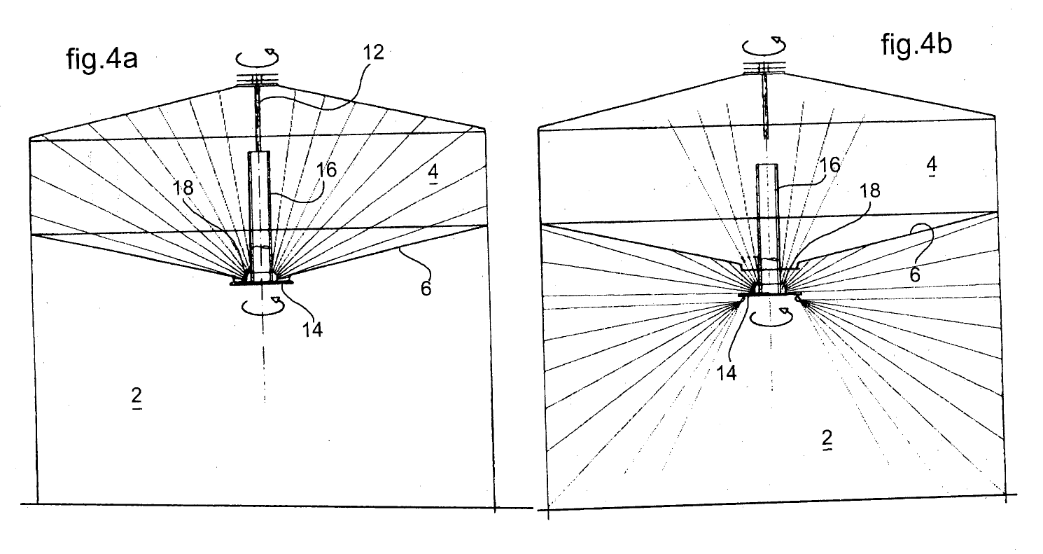

In another embodiment shown in FIGS. 4a and 4b, a washing device is provided, associated with the plate 14, and is rotated, not by the reaction of the emerging jets, but by an actuator, preferably but not necessarily an electric actuator. This actuator may, for example, be the same device which serves to bring about, alternatively, the upward and downward movement of the closure member 10, and which is also arranged to rotate the rod 12 and the plate 14 of the closure member 10. In this case, further spray nozzles, for example of the type indicated 24 above (FIG. 6), may be fitted beneath the plate 14 to increase the efficiency of the system in washing the main tank 2.

It is intended that, the principle of the invention remaining the same, the forms of embodiment and details of construction may be varied widely with respect to those described and illustrated by way of non-limiting example.

The fermentation apparatus will preferably be provided with all of the accessories necessary or useful for carrying out the wine-making cycle automatically. In particular, the apparatus may comprise a control and operating unit arranged to control the wine-making cycle and to implement washing cycles by operating the washing means of the invention.

For this purpose, the control and operating unit may comprise a display screen and processing means arranged to display on the screen a representation of the washing means and/or of the parameters relating to the washing process.

What is claimed is:

1. Fermentation apparatus, particularly for wine-making, of the type comprising a main tank and a secondary tank, disposed on top of the main tank, having a lower opening for the discharge of the fermentation liquid into the main tank, and provided with a closure member movable vertically between a position for closure of the lower opening and an open position, wherein means for the output of jets of washing liquid are associated with the closure member in a manner such that the vertical movement of the closure member and of the washing means associated therewith enables the position of the washing jets to be adjusted.

2. Fermentation apparatus according to claim 1, which comprises a closure member provided with a rod and a plate, and in which the washing means comprise a hollow body which has a perforated wall and is associated with the plate, and a duct surrounding the rod for the supply of a washing liquid to the hollow body.

3. Fermentation apparatus according to claim 1, which comprises a closure member provided with a rod and a plate, and the washing means comprise a dynamic output device comprising a stator body restrained on the rod of the closure member and a rotor body which has a perforated wall, is mounted rotatably on the stator body, and defines, with the stator body, a chamber for the washing liquid.

4. Fermentation apparatus according to claim 3, wherein the washing means comprise a washing-liquid supply duct surrounding the rod of the closure member and communicating with the chamber.

5. Fermentation apparatus according to claim 2, wherein the washing means are mounted on top of the plate.

6. Fermentation apparatus according to claim 1, which comprises a closure member with a rod and a plate and washing means comprising a dynamic output device with rotating tubular arms, mounted rotatably beneath the plate, and a washing-liquid supply pipe communicating with the tubular arms and disposed inside the rod of the closure member.

7. Fermentation apparatus according to claim 1, wherein the washing means comprise- a dynamic output device with a perforated head mounted rotatably on the end of a washing-liquid supply pipe.

8. Fermentation apparatus according to claim 3, comprising, in combination, a dynamic output device as defined in claim 3 and a second dynamic output device with rotating tubular arms, mounted rotatably beneath the plate.

9. Fermentation apparatus according to claim 1, wherein the washing means comprise a jet-output device associated with the plate and actuator means suitable for rotating the plate.

10. Fermentation apparatus according to claim 9, which comprises actuator means suitable for bringing about the vertical movement of the closure member, and in which the actuator means are arranged to rotate the plate.

11. Apparatus according to claim 1, comprising a closure member with a rod and a plate, in which the plate is positioned inside the main tank so that the closure travel of the closure member involves the raising of the plate towards the base of the secondary tank.
